(19) United States
(12) Patent Application Publication
(10) Pub. No.: US 2012/0255671 A1
(43) Pub. Date: Oct. 11, 2012

(54) METHOD FOR PRODUCING A MULTI-PLY WEB OF FLEXIBLE MATERIAL

(75) Inventors: Paul Wallstabe, Kerpen (DE); Eva-Li Saarväli, Vastra Frolunda (SE)

(73) Assignee: SCA HYGIENE PRODUCTS AB, Göteborg (SE)

(21) Appl. No.: 13/518,091

(22) PCT Filed: Dec. 23, 2009
(86) PCT No.: PCT/SE2009/051497

§ 371 Date: Jun. 29, 2012

(51) Int. Cl. B32B 37/02; B32B 38/06

(52) U.S. Cl. 156/210

(57) ABSTRACT

A method for producing a multi-ply web including at least three plies of flexible material, such as paper and nonwoven material, by means of gluing the plies. The method includes the steps of embossing first and second webs of flexible material separately between a respective embossing roll and a respective impression roll; applying glue to one side of each of the embossed first and second webs; feeding the first and second webs and a third web separately into a laminating nip. The third web is between the first and second webs, and the glue is applied to sides of the first and second webs facing the third web so that the first, second and third webs are combined in a single step. The laminating nip is formed between the first embossing roll and a laminating roll.

### CROSS-REFERENCE TO RELATED APPLICATIONS

This application is a §371 National Stage Application of PCT International Application No. PCT/SE2009/051497 filed Dec. 23, 2009, which is incorporated herein in its entirety.

### TECHNICAL FIELD

The present disclosure refers to a method for producing a multi-ply web including at least three plies of flexible material, such as paper and nonwoven material, by means of gluing the plies. Especially it refers to the production of tissue products such as toilet and kitchen paper, paper towels, hand towels, napkins, handkerchiefs, wiping material and the like.

### BACKGROUND

It is very common to laminate two or more tissue plies in order to produce the final tissue product. A laminated product gives a more flexible and softer tissue product as compared to if one single ply with a corresponding thickness and basis weight had been produced. The absorbent capacity and the bulk are moreover improved.

The lamination of two or more tissue plies is often made by means of gluing. A mechanical embossing of the plies is also often performed before they are glued together. It is further known to laminate two plies only by means of a mechanical embossing, at which a mechanical joining of the plies occurs in the embossing sites.

When laminating three or more plies by gluing, two or more lamination stations are usually used, in which each lamination station includes a glue application device and one web is added to another web in each lamination station. This is the case, for example, in WO 2005/085526, which discloses a multi-ply web including at least three plies and a

PATENT method and device for producing it. In one embodiment, two lamination stations are provided, each having a glue application unit, which enables a first and a second tissue ply to be laminated with glue in a first lamination station and a third tissue ply is laminated to the combined first and second plies in a second lamination station. Thus, two running webs are combined in each lamination station. Running designs/embossing/laminating in register is more difficult having single standing embossing/laminating units.

In an alternative embodiment, in WO 2005/085526 only one lamination station and one glue application device is provided wherein all three plies are combined in said one lamination station by having the glue penetrating completely through the middle layer in order to glue all layers together at the same time. An insufficient penetration of the glue through the middle layer will not provide a sufficient ply-bonding effect.

The use of several lamination stations involves a high machinery cost and is space-consuming. Having the glue penetrating completely through the middle layer may negatively effect the stiffness of the product and problems with ply-bonding may occur if the penetration of the glue is insufficient. In order to avoid insufficient penetration, an excess of low viscous glue may be used, which, however, may cause problems in the process and problems with product quality.

### SUMMARY

It is desired to provide a method for producing a multi-ply web of flexible material, such as paper and/or nonwoven, wherein at least three plies of flexible material are laminated together by gluing. The method should be adapted to compact and space saving process equipment, and lamination should provide a good ply-bonding effect without the need for the glue to penetrate completely through the middle ply.

This can be provided in a first aspect, which includes a method including the steps of:
embossing a first web of flexible material defining a first outer surface of said multiply web in a nip between a first embossing roll and a first impression roll;
applying glue to one side of the embossed first web by a first glue transfer roll;
embossing a second web of flexible material defining a second outer surface of said multiply web in a nip between a second embossing roll and a second impression roll;
applying glue to one side of the embossed second web by a second glue transfer roll;
combining said first and second webs with a third web, said third web being between the first and second webs, in a laminating nip to produce a multi-ply web, wherein the glue applied sides of the first and second outer webs are facing the third web, and
feeding the first, second and third webs of flexible material separately into said laminating nip, so that the first, second and third webs are combined in a single step, wherein said laminating nip is formed between said first embossing roll and a laminating roll.

In one aspect, one or more of said first, second and third webs include two or more plies of web shaped flexible material.

In a further aspect, the third web is embossed before entering the laminating nip.

In one aspect, the second web travels in a “free draw” from the nip between the second embossing roll and the second impression roll to the laminating nip.

In a further aspect, the glue applied on the second web will dry to a higher extent than the glue applied on the first web before lamination with the third web in the laminating nip, so that glue will penetrate deeper into the third web on the side facing the first web than on the side facing the second web, causing a higher ply-bonding effect between the first and third web than between the second and third web.

In a still further aspect, different glues are used on the first and second glue transfer rolls, respectively, to compensate for the drying effect in the “free draw” of the second web, so that the ply-bonding effect will be substantially equal between the first and second web and between the second and third web.

In another aspect, the first and second embossing rolls have identical embossment patterns. Alternatively, the first and second embossing rolls have different embossment patterns.

In one aspect, a fourth web is combined with the first, second and third webs in the laminating nip, said fourth web being between the third web and any of the first and second webs.

Further embodiments of the invention are disclosed in the following description, with the invention being defined by the claims.

### BRIEF DESCRIPTION OF THE DRAWINGS

Embodiments of the invention will, in the following, be closer described with reference to the embodiments shown in the accompanying drawings.

FIG. 1 shows a schematic side view of a device for performing an exemplary method according to an embodiment of the invention.

FIG. 2 is a schematic and enlarged section through a multi-ply product according to an embodiment of the invention.

FIG. 3 shows a detail from FIG. 2 on an enlarged scale.

### DEFINITIONS

Tissue Paper

A tissue paper is defined as a soft absorbent paper having a basis weight below 65 g/m² and typically between 10 and 50 g/m². The density of tissue paper is typically below 0.60 g/cm³, preferably below 0.30 g/cm³, and more preferably between 0.06 and 0.20 g/cm³.

Tissue paper can be manufactured and dried in different ways. A method which is commonly used for drying tissue paper is so called yankee drying. In yankee drying the moist paper web is pressed against a steam-heated yankee cylinder, which can have a very large diameter. The paper web is usually creped against the yankee cylinder. This method may also be referred to as dry creping.

Another drying method is so called through-air-drying (TAD). In this method, the paper is dried by means of hot air blown through the moist paper web, often without a preceding wet pressing. In connection with the TAD drying, the patterned structure of the drying fabric is transferred to the paper web. This structure is essentially maintained also in wet condition of the paper, since it has been imparted to the wet paper web.

The present disclosure refers to all types of tissue paper. The tissue paper may be creped or non-creped. The creping may take place in wet or dry condition. It may further be foreshortened by any other methods, such as so called rush transfer between wires.

The fibers contained in the tissue paper are mainly pulp fibers from chemical pulp, mechanical pulp, thermo mechanical pulp, chemo mechanical pulp and/or chemo thermo mechanical pulp (CTMP). The fibers may also be recycled fibers. The tissue paper may also contain other types of fibers enhancing e.g. strength, absorption or softness of the paper. These fibers may be made from regenerated cellulose or synthetic material such as polyolefins, polyesters, polyamides etc.

Ply

A paper comes out from the paper machine as a single-ply sheet, which later in the converting process can be combined with other plies by a lamination process, such as gluing and or embossing, to form a multi-ply material. The same applies to a nonwoven material or other web-shaped flexible material. A single ply may include one, two or more layers, for example, obtained by using a multi-layered headbox, by forming the web layers on top of each other in a sequential mode, or by forming each layer in a separate forming unit before couching the layers together in the paper machine while still in a wet condition.

Web

A web may include one single ply or two or more plies combined together and running in the machine as a unit.

Nonwoven

A nonwoven material is a manufactured sheet, web or batt of directionally or randomly oriented fibers bonded by friction, cohesion and/or adhesion, excluding paper and products that are woven, knitted, tufted or felted. The fibers may be of natural or man-made origin. They may also be staple fibres or continuous filament. Examples of commonly occurring nonwoven materials are hydroentangled, spunbonded, meltblown, carded and thermobonded materials.

### DETAILED DESCRIPTION OF PREFERRED EMBODIMENTS

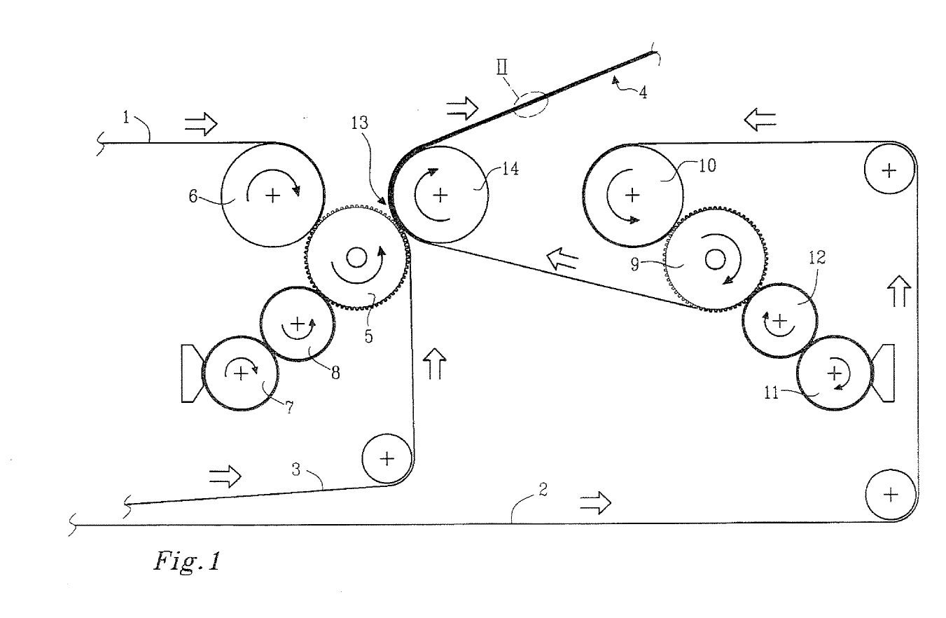

FIG. 1 shows a device for producing a three-ply material 4, e. g. paper, especially tissue paper. Combinations of different web-shaped materials, such as different types of paper, nonwoven materials etc. can be laminated together according to the method of an embodiment of the present invention. A first web 1 is brought into a first embossing nip between a first embossing roll 5 and a first impression roll 6. The first embossing roll 5 is along its periphery provided with a pattern of protuberances and the first impression roll 6 is of an elastically yielding material so that the pattern of protuberances is impressed into the paper web 1. A first glue application device includes a first glue chamber 7 from which glue is applied onto a first glue roll 8. The first glue roll 8 transfers glue to the tops of the embossed protuberances of the first web 1 in a glue transfer nip between the first embossing roll 5 and the first glue roll 8. The glue pattern applied on the first web, thus corresponds to the embossing pattern.

A second web 2 is brought into a second embossing nip between a second embossing roll 9 and a second impression roll 10. The second embossing roll 9 is along its periphery provided with a pattern of protuberances, which may be the same as or different from the pattern of the first embossing roll 5. The second impression roll 10 is of an elastically yielding material so that the pattern of protuberances is impressed into the second web 2. A second glue application device includes a second glue chamber 11 from which glue is applied onto a second glue roll 12. The second glue roll 12 transfers glue to the tops of the embossed protuberances of the second web 2 in a glue transfer nip between the second embossing roll 9 and the second glue roll 12. The glue pattern corresponds to the embossing pattern. The first and second embossing/glue application stations are run in register or not in register.

A third web 3 is fed towards a lamination nip 13 between the first embossing roll 5 and a laminating roll 14, a so called marrying roll. The third web 3 is here combined with the first and second webs 1 and 2 to produce a multi-ply web 4. The third web 3 forms a middle ply between the first and second webs 1 and 2 forming the outer plies of the multi-ply web 4. The sides of the first and second webs 1 and 2 having glue applied thereon are facing inwards towards the third web 3. The first, second and third webs 1, 2 and 3 are fed separately into the laminating nip 13, so that all the webs are combined in one single laminating step.

This process solution gives a compact and space-saving unit and register is directly given easily, if wished, for the lamination without the need for additional synchronization equipment. The process is further applicable in most conventional machines, avoiding costs for new machinery.

Any of the first, second or third webs 1, 2 and 3 may include a single ply of flexible material, for example paper, or may include two or more plies which have previously been combined by mechanical embossing and/or gluing. The third web 3 may be embossed or non-embossed when entering the laminating nip 13.

The pressure in the laminating nip 13 between the first embossing roll 5 and the laminating roll 14 can be rather low or moderate and only sufficient to adhere the webs together without the need for the glue to penetrate completely through any ply. This means that the lamination step is lenient to the product and to the embossing patterns.

The glue used can be relatively viscous since it does not need to penetrate through any ply, but may be present only on the surface of the plies. The amount of glue applied in each glue application station can be kept rather low since glue is applied on both the first and the second web. This positively effects the softness and drapability of the multi-ply web.

The outer first and second webs 1 and 2 each present a glue-free outer surface, which provides a multi-ply product with enhanced absorption and softness properties.

Examples of glues suitable for the purpose of embodiments of the invention are polyvinyl alcohol (PVOH), starch, methyl cellulose and the like.

Coloured glues may be used, which give a visual effect and therewith a patterning effect to the material.

The embossing patterns provided by the first and second embossing rolls 5 and 9, and subsequently the glue patterns can be optional, but should be chosen so that glue is applied to the respective paper web in an amount corresponding to between 1.5 and 12%, preferably between 2 and 7% of the total surface area of the respective paper web. As mentioned above, the embossing pattern, and thus the glue pattern on the second web 2 may be the same as or different from that on the first web 1.

The embossment and glue pattern can be of any optional shape, such as small points, lines, figures, letters, fantasy patterns etc.

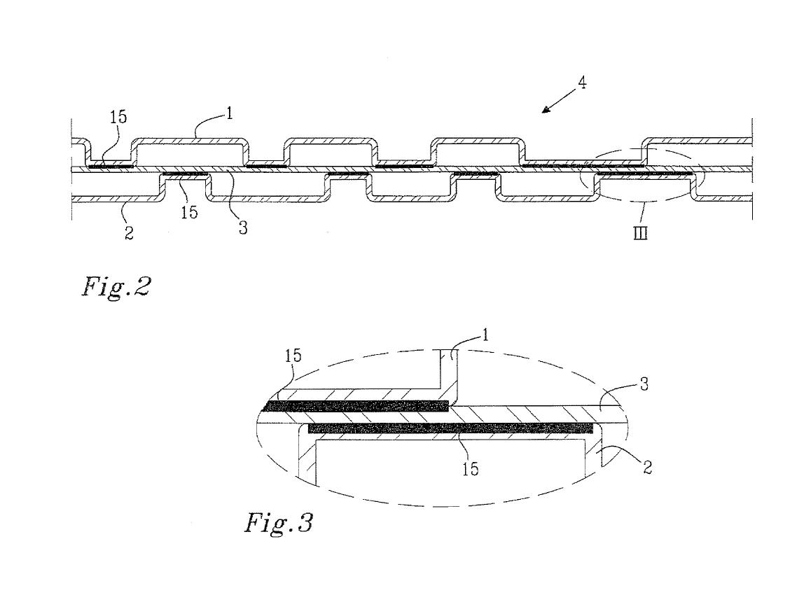

FIG. 2 illustrates a multi-ply web 4 wherein the outer plies 1 and 2, formed by the first and second webs, are embossed and the middle ply 3, formed by the third web, is unembossed. The middle ply 3 keeps the embossed outer plies 1 and 2 apart and prevents the embossed areas from nesting into each other, thus maintaining the bulk of the multi-ply product. The glued areas are indicated with the reference numeral 15. It is noted that although referred to as “plies,” any of the outer plies 1 and 2 and/or the middle ply 3 may be formed of two or more plies as described above.

As can be seen from FIG. 1, the second embossing roll 9 is spaced apart a certain distance from the laminating nip 13, so that there is a “free draw” of the second web 2 having glue applied on one side thereof, before it enters the laminating nip. This means that the glue will dry at least to a certain extent before being exerted to the pressure in the laminating nip. Therefore, the lamination will not cause any significant penetration of the glue under the surface of the third web 3.

However, the first embossing roll 5 forms part of the laminating nip 13, so that there will be no “free draw” of the first web 1 having glue applied on one side thereof, before it enters the laminating nip. This means that the glue will dry to a less extent as compared to on the second web 2 before being exerted to the pressure in the laminating nip. Therefore, the glue may penetrate a certain distance under the surface of the third web 3, and at least to a higher degree than on the opposite side of the third web facing the second web 2. This is illustrated in FIG. 3 of the drawings, where the glue is indicated with the reference numeral 15.

This difference in glue penetration on the opposite sides of the third web 3 is noticeable on the multi-ply product 4, and will cause a difference in ply-bonding effect between the different plies, so that when trying to separate the different plies from each other, such separation will more easily occur between the middle ply 3 and the second outer ply 2. At least the main part of the glue 15 will remain on the second outer ply 2. Separation between the first outer ply 1 and the middle ply 3 will be more difficult, since the glue has penetrated deeper under the surface of the middle ply on this side.

In case it is desired to have the same or similar ply-bonding effect between all plies, different glues may be used in the glue application stations. For example, different glues may be selected with respect to viscosity or composition of the glue, so that the difference in the drying effect caused by different travelling lengths of the first and second webs having glue applied thereon is compensated.

The paper webs 1, 2 and 3 that are laminated can be smooth, but also have a three-dimensional structure provided earlier in the process, for example, during forming, dewatering and/or drying of the paper web. A three-dimensional structure may also be provided by embossing the dry paper webs before entering the embossing and glue stations.

Four or more paper webs may of course be laminated. When laminating four webs in the lamination nip 13, two middle webs are entered between the first and second webs 1 and 2, wherein one middle web has glue applied on one side thereof provided by a glue application station in a similar way as for the first and second webs 1 and 2. A fifth web and further webs having one glue applied side may be added between the third and fourth webs. It would also be possible to have glue penetrating any of the middle webs, so that the fourth web does not need to have any glue applied thereon.

Glues with different properties with respect to, for example, viscosity may be used in the different glue stations, for example, with different viscosity properties. Different glues may also be used when laminating plies of different material, for example, combinations of tissue paper, nonwoven material and/or oven paper.

Different kinds of paper and nonwoven materials with different properties with respect to absorption capacity, basis weight, manufacturing technique, fiber composition, and chemical additives may be used in the different plies. The method is also adapted for use with rather thick and high basis weight materials as well as with non-absorbent or low absorbent materials, since the glue does not need to penetrate the plies completely in order to provide a ply-bonding effect.

1. A method for producing a multi-ply web including at least three plies of flexible material comprising the steps of:
embossing a first web of flexible material defining a first outer surface of said multiply web in a nip between a first embossing roll and a first impression roll;
applying glue to one side of the embossed first web by a first glue transfer roll;
embossing a second web of flexible material defining a second outer surface of said multiply web in a nip between a second embossing roll and a second impression roll;
applying glue to one side of the embossed second web by a second glue transfer roll;
combining said first and second webs with a third web, said third web being between the first and second webs, in a laminating nip to produce a multi-ply web, wherein the glue applied sides of the first and second outer webs are facing the third web, and
feeding the first, second and third webs of flexible material separately into said laminating nip, so that the first, second and third webs are combined in a single step, wherein said laminating nip is formed between said first embossing roll and a laminating roll.

2. The method as claimed in claim 1, wherein one or more of said first, second and third webs comprise two or more plies of web shaped flexible material.

3. The method as claimed in claim 1, wherein the third web is embossed before entering the laminating nip.

4. The method as claimed in claim 1, wherein the second web travels in a free draw from the nip between the second embossing roll and the second impression roll to the laminating nip.

5. The method as claimed in claim 4, wherein the glue applied on the second web will dry to a higher extent than the glue applied on the first web before lamination with the third web in the laminating nip, so that glue will penetrate deeper into the third web on the side facing the first web than on the side facing the second web, causing a higher ply-bonding effect between the first and third web than between the second and third web.

6. The method as claimed in claim 4, wherein different glues are used on the first and second glue transfer rolls, respectively, to compensate for the drying effect in the free draw of the second web, so that the ply-bonding effect will be substantially equal between the first and second web and between the second and third web.

7. The method as claimed in claim 1, wherein the first and second embossing rolls have identical embossment patterns.

8. The method as claimed in claim 1, wherein the first and second embossing rolls have different embossment patterns.

9. The method as claimed in claim 1, wherein a fourth web is combined with the first, second and third webs in the laminating nip, said fourth web being between the third web and any of the first and second webs.
